(19) United States
(12) Patent Application Publication
(10) Pub. No.: US 2012/0019096 A1
(43) Pub. Date: Jan. 26, 2012

(54) Stator for Electric Rotating Machine

(75) Inventors: Makoto TANIGUCHI, Obu-shi (JP); Masahiko Osada, Okazaki-shi (JP)

(73) Assignee: DENSO CORPORATION, Kariya-city (JP)

(21) Appl. No.: 13/160,792

(22) Filed: Jun. 15, 2011

(30) Foreign Application Priority Data
Jul. 20, 2010 (JP) 2010-162744

(51) Int. Cl. H02K 1/16

(52) U.S. Cl. 310/216.069

(57) ABSTRACT

A stator core is comprised of first and second stator core pieces that are arranged to overlap each other in the axial direction of the stator core. The first stator core piece includes first protrusions, each of which is formed on one circumferential side of a corresponding tooth portion of the stator core, and first slot opening portions that open on the radially inner surface of the first stator core piece. The second stator core piece includes second protrusions, each of which is formed on the other circumferential side of a corresponding tooth portion, and second slot opening portions that open on the radially inner surface of the second stator core piece. For each slot of the stator core, a corresponding pair of the first and second slot opening portions which communicate with the slot are offset from each other in the circumferential direction of the stator core.

### CROSS-REFERENCE TO RELATED APPLICATION

This application is based on and claims priority from Japanese Patent Application No. 2010-162744, filed on Jul. 20, 2010, the content of which is hereby incorporated by reference in its entirety into this application.

### BACKGROUND

1. Technical Field

The present invention relates to stators for electric rotating machines which include a stator core having a skew structure.

2. Description of Related Art

A permanent magnet motor generally has a plurality of field-use permanent magnets arranged in a rotor thereof. Moreover, there are known methods of reducing cogging torque of a permanent magnet motor, which causes vibration and noise to occur in the motor, by skewing either or both of a rotor and a stator of the motor.

For example, Japanese Patent Application Publication No. 2006-254622 discloses a permanent magnet motor which includes a stator core having a continuous skew structure. More specifically, the stator core has a plurality of slots that are formed in the radially inner surface of the stator core so as to extend continuously oblique with respect to the axial direction of the stator core.

However, with the continuous skew structure, it may be difficult to ensure high productivity and minimize the manufacturing cost of the stator core.

More specifically, the stator core is formed by laminating a plurality of thin magnetic steel sheets. Accordingly, for realizing the continuous skew structure of the stator core, in laminating the magnetic steel sheets, it is necessary to offset the slot positions of each of the magnetic steel sheets in the circumferential direction of the stator core from those of all the other magnetic steel sheets. In other words, it is necessary to circumferentially position each of the magnetic steel sheets during the process of laminating the magnetic steel sheets to form the stator core. Consequently, the productivity of the stator core may be lowered and thus the manufacturing cost of the stator core may be increased in comparison with a conventional stator core without a skew structure.

Moreover, with the continuous skew structure of the stator core, it is impossible to wind a stator coil of the stator around the stator core using a conventional winding method that employs a winding nozzle.

Otherwise, the stator coil may be mounted to the stator core by inserting conductor segments, which together make up the stator coil, into corresponding slots of the stator core. However, in this case, it is difficult to smoothly insert the conductor segments into the corresponding slots due to the continuous skew structure of the stator core, in other words, due to the continuously oblique formation of the slots in the stator core with respect to the axial direction of the stator core.

### SUMMARY

According to one embodiment, there is provided a stator for an electric rotating machine. The stator includes a stator core that has an annular back yoke portion, a plurality of tooth portions and a plurality of slots. Each of the tooth portions extends radially inward from a radially inner periphery of the back yoke portion. The tooth portions are arranged in a circumferential direction of the back yoke portion at predetermined intervals. Each of the slots is formed between a circumferentially-adjacent pair of the tooth portions. The stator core is comprised of first and second stator core pieces that are arranged to overlap each other in an axial direction of the back yoke portion of the stator core. The first stator core piece includes a plurality of first protrusions and a plurality of first slot opening portions. Each of the first protrusions is formed on a first circumferential side of a corresponding one of the tooth portions of the stator core so as to protrude from a distal end part of the corresponding tooth portion in the circumferential direction. Each of the first slot opening portions is formed between a circumferentially-adjacent pair of one of the first protrusions and one of the distal end parts of the tooth portions of the stator core so as to extend in the axial direction. Each of the first slot opening portions communicates with a corresponding one of the slots of the stator core and opens on a radially inner surface of the first stator core piece. The second stator core piece includes a plurality of second protrusions and a plurality of second slot opening portions. Each of the second protrusions is formed on a second circumferential side of a corresponding one of the tooth portions of the stator core so as to protrude from the distal end part of the corresponding tooth portion in the circumferential direction. The second circumferential side is opposite to the first circumferential side for each of the tooth portions of the stator core. Each of the second slot opening portions is formed between a circumferentially-adjacent pair of one of the second protrusions and one of the distal end parts of the tooth portions of the stator core so as to extend in the axial direction. Each of the second slot opening portions communicates with a corresponding one of the slots of the stator core and opens on a radially inner surface of the second stator core piece. For each of the slots of the stator core, the corresponding pair of the first and second slot opening portions which communicate with the slot are offset from each other in the circumferential direction of the back yoke portion of the stator core.

According to another embodiment, there is provided a stator for an electric rotating machine. The stator includes a stator core that has an annular back yoke portion, a plurality of tooth portions and a plurality of slots. Each of the tooth portions extends radially outward from a radially outer periphery of the back yoke portion. The tooth portions are arranged in a circumferential direction of the back yoke portion at predetermined intervals. Each of the slots is formed between a circumferentially-adjacent pair of the tooth portions. The stator core is comprised of first and second stator core pieces that are arranged to overlap each other in an axial direction of the back yoke portion of the stator core. The first stator core piece includes a plurality of first protrusions and a plurality of first slot opening portions. Each of the first protrusions is formed on a first circumferential side of a corresponding one of the tooth portions of the stator core so as to protrude from a distal end part of the corresponding tooth portion in the circumferential direction. Each of the first slot opening portions is formed between a circumferentially-adjacent pair of one of the first protrusions and one of the distal end parts of the tooth portions of the stator core so as to extend in the axial direction. Each of the first slot opening portions communicates with a corresponding one of the slots of the stator core and opens on a radially outer surface of the first stator core piece. The second stator core piece includes a plurality of second protrusions and a plurality of second slot opening portions. Each of the second protrusions is formed on a second circumferential side of a corresponding one of the tooth portions of the stator core so as to protrude from the distal end part of the corresponding tooth portion in the circumferential direction. The second circumferential side is opposite to the first circumferential side for each of the tooth portions of the stator core. Each of the second slot opening portions is formed between a circumferentially-adjacent pair of one of the second protrusions and one of the distal end parts of the tooth portions of the stator core so as to extend in the axial direction. Each of the second slot opening portions communicates with a corresponding one of the slots of the stator core and opens on a radially outer surface of the second stator core piece. For each of the slots of the stator core, the corresponding pair of the first and second slot opening portions which communicate with the slot are offset from each other in the circumferential direction of the back yoke portion of the stator core.

With the above configurations of the stators according to the embodiments, it is possible to impart to the stator core a stepped skew structure. Further, with the stepped skew structure, when the electric rotating machine is configured as a motor, it is possible to reduce torque ripple of the motor, thereby suppressing fluctuations in rotational movement of the motor and reducing magnetic noise generated by the motor.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is an axial end view of a stator core of a stator for an electric rotating machine according to the first embodiment of the invention;

FIG. 2 is a perspective view of part of the stator core;

FIG. 3 is a perspective view of part of a first stator core sheet for forming the stator core;

FIG. 4 is a perspective view of part of a second stator core sheet for forming the stator core;

FIG. 5A is a waveform chart illustrating the waveform of torque generated by a first permanent magnet synchronous motor which employs the stator core according to the first embodiment;

FIG. 5B is a waveform chart illustrating the waveform of torque generated by a second permanent magnet synchronous motor which employs a conventional stator core without a skew structure;

FIG. 6 is a perspective view of part of a first stator core sheet according to the second embodiment of the invention;

FIG. 7 is a perspective view of part of a second stator core sheet according to the second embodiment;

FIG. 8 is a perspective view of part of a stator core according to the third embodiment of the invention;

FIG. 9 is a perspective view of part of a third stator core sheet for forming a third stator core piece of the stator core according to the third embodiment;

FIG. 10 is a perspective view of part of a stator core according to the fourth embodiment of the invention;

FIG. 11 is a perspective view of part of another stator core according to the fourth embodiment;

FIG. 12 is a perspective view of a conductor segment for forming a stator coil according to the fifth embodiment of the invention;

FIG. 13 is a perspective view illustrating part of a stator according to the fifth embodiment;

FIG. 14 is a perspective view of part of a stator core according to the sixth embodiment of the invention;

FIG. 15 is an axial end view of a stator core according to the seventh embodiment of the invention; and

FIG. 16 is a perspective view of part of the stator core according to the seventh embodiment.

### DESCRIPTION OF PREFERRED EMBODIMENTS

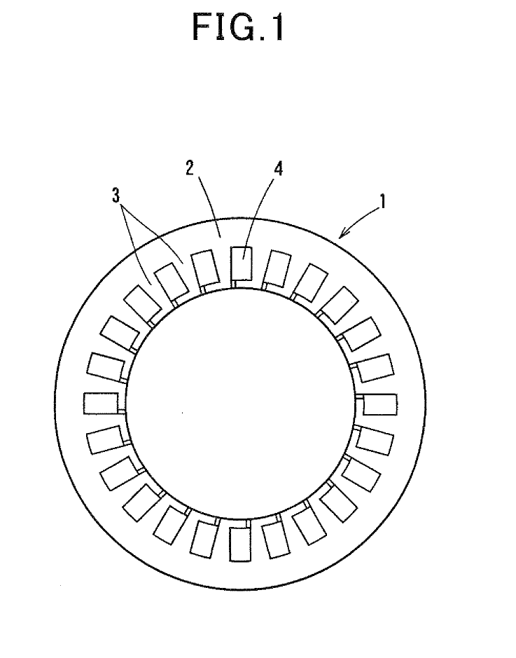

Preferred embodiments of the present invention will be described hereinafter with reference to FIGS. 1-16. It should be noted that for the sake of clarity and understanding, identical components having identical functions in different embodiments of the invention have been marked, where possible, with the same reference numerals in each of the figures and that for the sake of avoiding redundancy, descriptions of the identical components will not be repeated.

### First Embodiment

FIG. 1 shows the overall configuration of a stator core 1 of a stator according to the first embodiment of the invention. The stator is designed to be used in a permanent magnet synchronous motor that has a plurality of permanent magnets arranged in a rotor (not shown) of the motor. In addition, in this embodiment, the motor is explained as an inner rotor-type motor in which the rotor is disposed radially inside the stator.

As shown in FIG. 1, the stator core 1 includes an annular back yoke portion 2, a plurality of tooth portions 3 and a plurality of slots 4. Each of the tooth portions 3 extends radially inward from a radially inner periphery of the back yoke portion 2. The tooth portions 3 are arranged at predetermined intervals in the circumferential direction of the stator core 1 (i.e., in the circumferential direction of the annular back yoke portion 2). Each of the slots is formed between a circumferentially-adjacent pair of the tooth, portions 3.

In addition, in the present embodiment, both the number of the tooth portions 3 and the number of the slots 4 are set to be equal to 24. Further, as shown in FIG. 1, all the intervals between the slots 4 in the circumferential direction of the stator core 1 are equally set. Consequently, the sole slot pitch of the stator core 1 is equal to 15°. However, it should be noted that the intervals between the slots 4 in the circumferential direction of the stator core 1 may also be differently set. For example, the slots 4 may be arranged in the circumferential direction of the stator core 1 at two different slot pitches, one of which is equal to, for example, 14° and the other is equal to 16°.

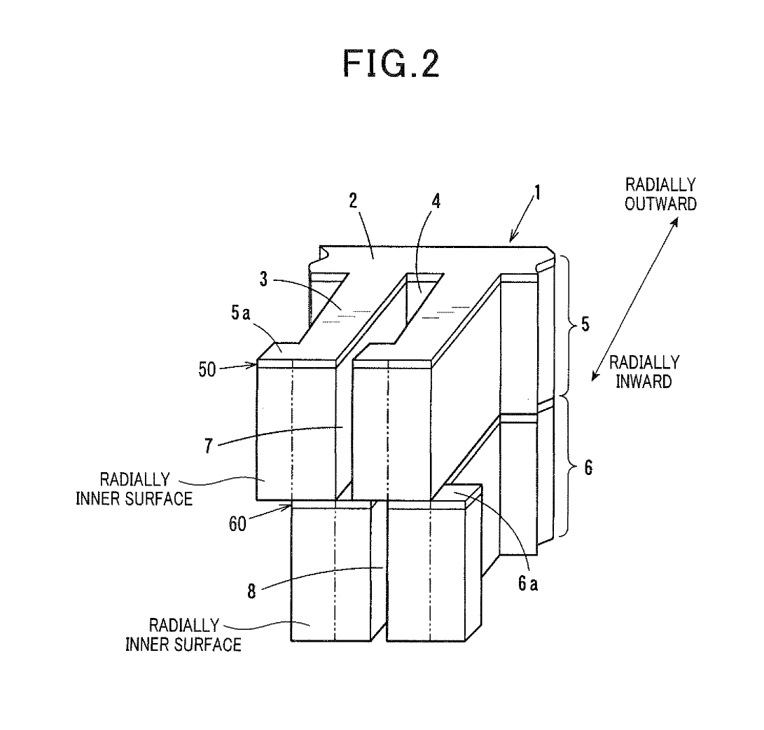

Referring now to FIG. 2, in the present embodiment, the stator core 1 is comprised of first and second stator core pieces 5 and 6 that are arranged to overlap each other in the axial direction of the stator core 1 (i.e., in the axial direction of the annular back yoke portion 2). The first stator core piece 5 includes a plurality of first protrusions 5a each of which is formed on a first circumferential side (i.e., the left side in FIG. 2) of a corresponding one of the tooth portions 3 of the stator core 1 so as to protrude from a distal end part of the corresponding tooth portion 3 in the circumferential direction. The second stator core piece 6 includes a plurality of second protrusions 6a each of which is formed on a second circumferential side (i.e., the right side in FIG. 2) of a corresponding one of the tooth portions 3 of the stator core 1 so as to protrude from the distal end part of the corresponding tooth portion 3 in the circumferential direction. In addition, for each of the tooth portions 3 of the stator core 1, the first and second circumferential sides of the tooth portion 3 are opposite to each other.

Moreover, the first stator core piece 5 also includes a plurality of first slot opening portions 7 each of which is formed between a circumferentially-adjacent pair of one of the first protrusions 5a and one of the distal end parts of the tooth portions 3. Each of the first slot opening portions 7 communicates with a corresponding one of the slots 4 of the stator core 1 and opens on the radially inner surface of the first stator core piece 5. On the other hand, the second stator core piece 6 also includes a plurality of second slot opening portions 8 each of which is formed between a circumferentially-adjacent pair of one of the second protrusions 6a and one of the distal end parts of the tooth portions 3. Each of the second slot opening portions 8 communicates with a corresponding one of the slots 4 of the stator core 1 and opens on the radially inner surface of the second stator core piece 6. In addition, the radially inner surfaces of the first and second stator core pieces 5 and 6 are to face the rotor of the motor which is to be disposed radially inside the stator. Consequently, each of the slots 4 of the stator core 1 can communicate with an annular gap formed between the stator and the rotor of the motor via the corresponding pair of the first and second slot opening portions 7 and 8.

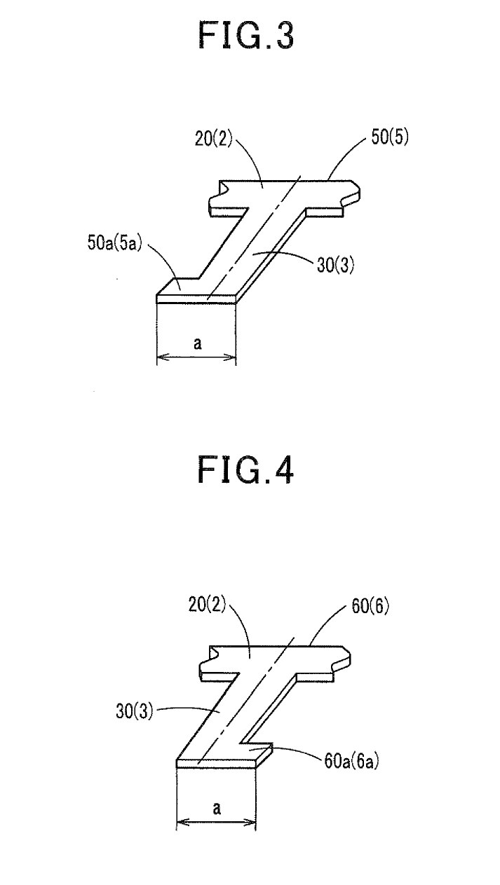

In the present embodiment, the first stator core piece 5 is formed by laminating a plurality of first stator core sheets 50. As shown in FIG. 3, each of the first stator core sheets 50 has an annular portion 20 that makes up part of the back yoke portion 2 of the stator core 1, a plurality of tooth portions 30 each of which makes up part of a corresponding one of the tooth portions 3 of the stator core 1, and a plurality of first protrusions 50a each of which makes up part of a corresponding one of the first protrusions 5a of the first stator core piece 5.

On the other hand, the second stator core piece 6 is formed by laminating a plurality of second stator core sheets 60. As shown in FIG. 4, each of the second stator core sheets 60 has an annular portion 20 that makes up part of the back yoke portion 2 of the stator core 1, a plurality of tooth portions 30 each of which makes up part of a corresponding one of the tooth portions 3 of the stator core 1, and a plurality of second protrusions 60a each of which makes up part of a corresponding one of the second protrusions 6a of the second stator core piece 6. In addition, the first and second stator core sheets 50 and 60 may be formed by, for example, punching thin magnetic steel sheets.

Moreover, in the present embodiment, the thickness of the first stator core sheets 50 is set to be equal to that of the second stator core sheets 60. Further, the shape of the first stator core sheets 50 and the shape of the second stator core sheets 60 are mirror images of each other.

More specifically, as shown in FIGS. 3 and 4, for each of the tooth portions 30 of the first stator core sheets 50, the sum of circumferential widths of the distal end part of the tooth portion 30 and the first protrusion 50a protruding from the distal end part is set to be equal to a predetermined value a. Similarly, for each of the tooth portions 30 of the second stator core sheets 60, the sum of circumferential widths of the distal end part of the tooth portion 30 and the second protrusion 60a protruding from the distal end part is also set be equal to the predetermined value a. Further, the shape of the tooth portions 30 of the first stator core sheets 50 is the same as that of the tooth portions 30 of the second stator core sheets 60. Furthermore, the first protrusions 50a of the first stator core sheets 50 have the same shape as the second protrusions 60a of the second stator core sheets 60; however, the protruding direction of the first protrusions 50a is opposite to that of the second protrusions 60a.

Consequently, referring back to FIG. 2, in the first stator core piece 5 that is obtained by laminating the first stator core sheets 50, each of the first protrusions 5a is formed on the first circumferential side of the corresponding tooth portion 3 of the stator core 1. Accordingly, for each of the first slot opening portions 7, the circumferential center of the first slot opening portion 7 is also located on the first circumferential side of the circumferential center of the corresponding slot 4 of the stator core 1. On the other hand, in the second stator core piece 6 that is obtained by laminating the second stator core sheets 60, each of the second protrusions 6a is formed on the second circumferential side of the corresponding tooth portion 3 of the stator core 1. Accordingly, for each of the second slot opening portions 8, the circumferential center of the second slot opening portion 8 is also located on the second circumferential side of the circumferential center of the corresponding slot 4 of the stator core 1.

As a result, in the stator core 1 that is obtained by stacking the first and second stator core pieces 5 and 6 in the axial direction, for each of the slots 4, the corresponding pair of the first and second slot opening portions 7 and 8, both of which communicate with the slot 4 and extend in the axial direction of the stator core 1, are offset from each other in the circumferential direction of the stator core 1. That is to say, all of the first slot opening portions 7 opening on the radially inner surface of the first stator core piece 5 and the second slot opening portions 8 opening on the radially inner surface of the second stator core piece 6 together make up a stepped skew structure of the stator core 1.

Furthermore, in the present embodiment, the number of the first stator core sheets 50 is equal to the number of the second stator core sheets 60. Consequently, the axial length (i.e., the length in the axial direction of the stator core 1) of the first stator core piece 5 is equal to that of the second stator core piece 6.

In addition, in the present embodiment, the circumferential width of the first and second protrusions 5a and 6a is set to be greater than the circumferential width of the first and second slot opening portions 7 and 8 on the radially inner surfaces of the first and second stator core pieces 5 and 6.

After having described the overall structure of the stator according to the present embodiment, advantages thereof will be described hereinafter.

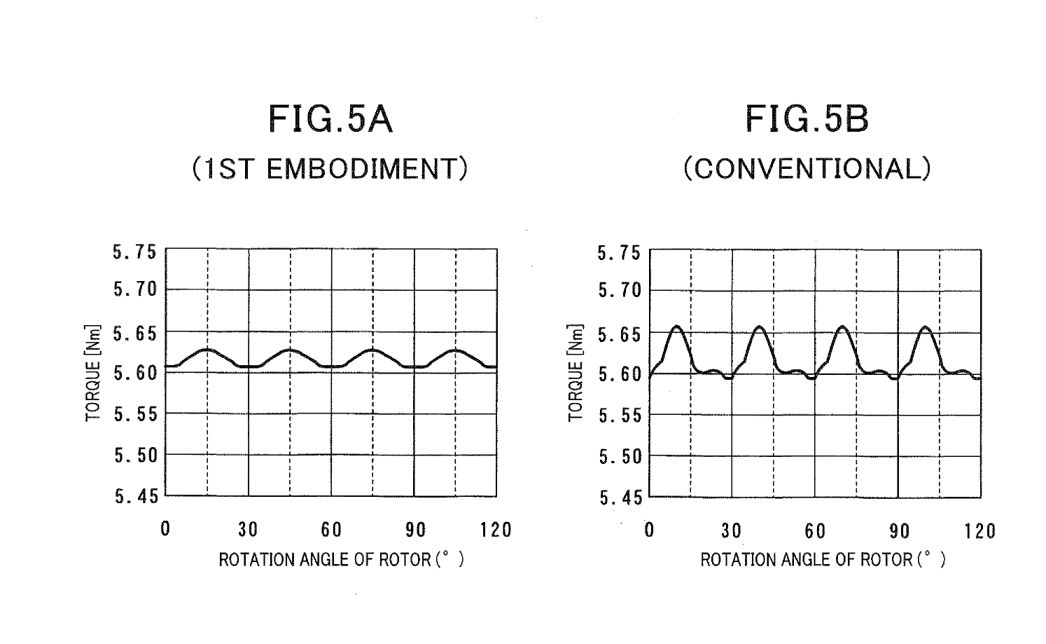

FIG. 5A illustrates the waveform of torque generated by a first permanent magnet synchronous motor which employs the stator core 1 according to the present embodiment. FIG. 5B illustrates the waveform of torque generated by a second permanent magnet synchronous motor which employs a conventional stator core without a skew structure.

It can be seen from FIGS. 5A and 5B that torque ripple of the first permanent magnet synchronous motor is much lower than that of the second permanent magnet synchronous motor. The stator core 1 according to the present embodiment has the stepped skew structure as described above. Accordingly, it is made clear that with the stepped skew structure of the stator core 1, it is possible to reduce torque ripple of the motor, thereby suppressing fluctuations in rotational movement of the motor and reducing magnetic noise generated by the motor.

Further, in the present embodiment, the first stator core piece 5 is formed by laminating the first stator core sheets 50, and the second stator core piece 6 is formed by laminating the second stator core sheets 60.

However, with the stepped skew structure of the stator core 1 according to the present embodiment, in laminating the first and second stator core sheets 50 and 60, it is unnecessary to offset them from one another in the circumferential direction of the stator core 1. Consequently, compared to the case of applying the continuous skew structure disclosed in Japanese Patent Application Publication No. 2006-254622, it is possible to improve the productivity and reduce the manufacturing cost of the stator core 1.

Furthermore, in the present embodiment, the thickness of the first stator core sheets 50 is equal to that of the second stator core sheets 60, and the shape of the first stator core sheets 50 and the shape of the second stator core sheets 60 are mirror images of each other.

With the above configuration, the first stator core sheets 50 and the second stator core sheets 60 can be made interchangeable simply by inverting them. Consequently, it is possible to make all of the first and second stator core sheets 50 and 60 by punching thin magnetic steel sheets using the same shaping dies.

In the present embodiment, the axial length of the first stator core piece 5 is set to be equal to the axial length of the second stator core piece 6.

Setting the axial lengths of the first and second stator core pieces 5 and 6 as above, the harmonic components of magnetic flux created between the first stator core piece 5 and the rotor of the motor can be completely canceled by those of magnetic flux created between the second stator core piece 6 and the rotor. As a result, it is possible to effectively reduce magnetic noise generated by the motor.

Moreover, in the present embodiment, the circumferential width of the first and second protrusions 5a and 6a is set to be greater than the circumferential width of the first and second slot opening portions 7 and 8 on the radially inner surfaces of the first and second stator core pieces 5 and 6.

With the above configuration, it is possible to achieve maximum “field-weakening effect”. Here, the field-weakening effect denotes an effect of weakening magnetic flux created by the permanent magnets of the rotor using magnetic flux created by the stator and thereby reducing the counter electromotive force induced in a stator coil of the stator. More specifically, setting the circumferential width of the first and second protrusions 5a and 6a as above, it is possible to secure a sufficiently low magnetic reluctance between the rotor and the stator of the motor, thereby allowing the magnetic flux created by the stator to effectively cancel the magnetic flux created by the rotor.

### Second Embodiment

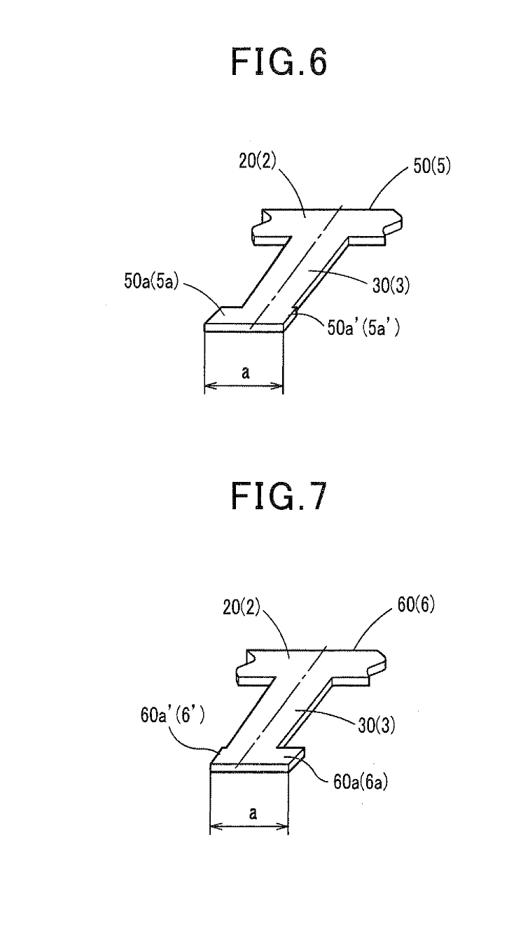

Referring to FIGS. 6 and 7, in this embodiment, each of the first stator core sheets 50 forming the first stator core piece 5 further includes a plurality of second protrusions 50a′ in addition to the first protrusions 50a. Each of the second protrusions 50a′ is formed on the second circumferential side (i.e., the right side in FIG. 6) of a corresponding one of the tooth portions 30 of the first stator core sheet 50 so as to protrude from the distal end part of the corresponding tooth portion 30 in the circumferential direction. Consequently, for each of the tooth portions 30, there are formed a pair of the first and second protrusions 50a and 50a′ respectively on the first and second circumferential sides of the tooth portion 30. On the other hand, each of the second stator core sheets 60 forming the second stator core piece 6 further includes a plurality of first protrusions 60a′ in addition to the second protrusions 60a. Each of the first protrusions 60a′ is formed on the first circumferential side (i.e., the left side in FIG. 7) of a corresponding one of the tooth portions 30 of the second stator core sheet 60 so as to protrude from the distal end part of the corresponding tooth portion 30 in the circumferential direction. Consequently, for each of the tooth portions 30, there are formed a pair of the first and second protrusions 60a′ and 60a respectively on the first and second circumferential sides of the tooth portion 30.

Accordingly, in the first stator core piece 5 obtained by laminating the first stator core sheets 50, for each of the tooth portions 3 of the stator core 1, there are formed a pair of first and second protrusions 50a and 50′ respectively on the first and second circumferential sides of the tooth portion 3. Moreover, in the second stator core piece 6 obtained by laminating the second stator core sheets 60, for each of the tooth portions 3 of the stator core 1, there are formed a pair of first and second protrusions 60a′ and 60a respectively on the first and second circumferential sides of the tooth portion 3.

Further, in the present embodiment, for the first stator core piece 5, the circumferential width of the first protrusions 5a is set to be different from (more particularly, greater than in FIG. 6) that of the second protrusions 5a′. For the second stator core piece 6, the circumferential width of the first protrusion 6a′ is set to be different from (more particularly, less than in FIG. 7) that of the second protrusions 6a.

Furthermore, in the present embodiment, the shape of the first stator core sheets 50 and the shape of the second stator core sheets 60 are mirror images of each other. Consequently, the circumferential width of the first protrusions 5a of the first stator core piece 5 is equal to that of the second protrusions 6a of the second stator core piece 6. The circumferential width of the second protrusions 5a′ of the first stator core piece 5 is equal to that of the first protrusions 6a′ of the second stator core piece 6.

Moreover, in the present embodiment, for each of the tooth portions 3 in the first stator core piece 5, the sum of circumferential widths of the distal end part of the tooth portion 3 and the pair of the first and second protrusions 5a and 5a′ protruding from the distal end part is set to be equal to the predetermined value a described in the first embodiment. Similarly, for each of the tooth portions 3 in the second stator core piece 6, the sum of circumferential widths of the distal end part of the tooth portion 3 and the pair of the first and second protrusions 6a and 6a′ protruding from the distal end part is also set to be equal to the predetermined value a.

Consequently, in the present embodiment, the first and second slot opening portions 7 and 8 are positioned closer to the circumferential centers of the corresponding slots 4 than in the first embodiment.

The stator core 1 according to the present embodiment has the same advantages as that according to the first embodiment.

In addition, in the present embodiment, it is possible to adjust the circumferential positions of the first and second slot opening portions 7 and 8 by adjusting the circumferential widths of the protrusions 5a and 5a′ of the first stator core piece 5 and the protrusions 6a and 6a′ of the second stator core piece 6. Further, by adjusting the circumferential positions of the first and second slot opening portions 7 and 8, it is possible to adjust the degree of reducing magnetic noise generated by the motor.

### Third Embodiment

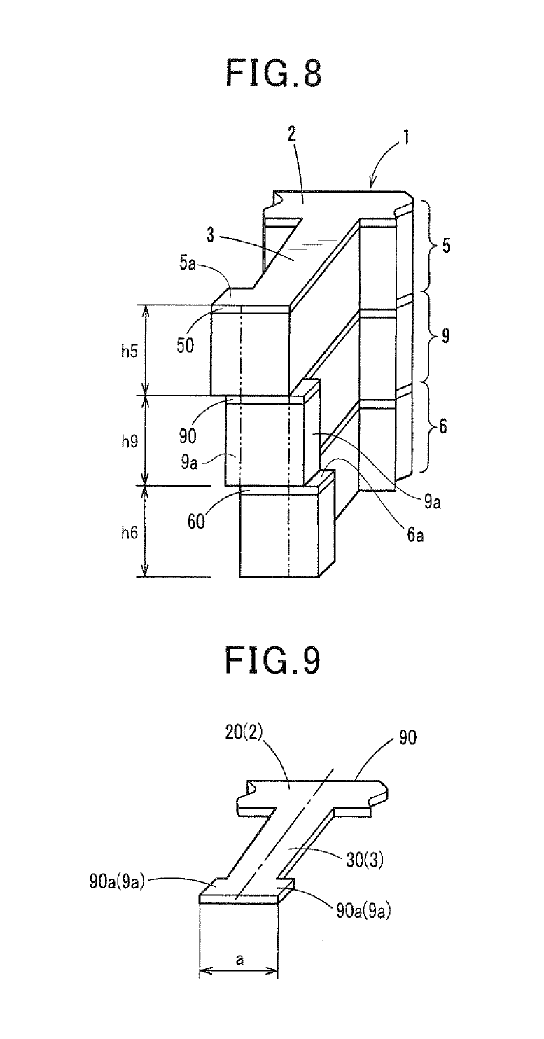

Referring to FIG. 8, in this embodiment, the stator core 1 further has a third stator core piece 9 interposed between the first and second stator core pieces 5 and 6 in the axial direction.

In the third stator core piece 9, for each of the tooth portions 3 of the stator core 1, there are formed a pair of third protrusions 9a respectively on opposite circumferential sides (i.e., the first and second circumferential sides) of the tooth portion 3 so as to protrude from the distal end part of the tooth portion 3 in the circumferential direction. The circumferential widths of the third protrusions 9a are set to be equal to each other.

In the present embodiment, the third stator core piece 9 is formed by laminating a plurality of third stator core sheets 90. As shown in FIG. 9, each of the third stator core sheets 90 has an annular portion 20 that makes up part of the back yoke portion 2 of the stator core 1, a plurality of tooth portions 30 each of which makes up part of a corresponding one of the tooth portions 3 of the stator core 1, and a plurality of third protrusions 90a each of which makes up part of a corresponding one of the third protrusions 9a of the third stator core piece 9. As the first and second stator core sheets 50 and 60, the third stator core sheets 90 may also be formed by, for example, punching thin magnetic steel sheets.

Further, for each of the tooth portions 30 of the third stator core sheets 90, the sum of circumferential widths of the distal end part of the tooth portion 30 and the pair of the third protrusions 90a protruding from the distal end part is set to be equal to the predetermined value a described in the first embodiment.

Consequently, referring again to FIG. 8, in the stator core 1 that is obtained by sequentially stacking the first, third, and second stator core pieces 5, 9, and 6 in the axial direction, the third protrusions 9a of the third stator core piece 9 less protrude from the corresponding distal end parts of the tooth portions 3 of the stator core 1 than the first and second protrusions 5a and 6a of the first and second stator core pieces 5 and 6. In addition, in the present embodiment, all of the axial lengths h5, h6 and h9 of the first, second and third stator core pieces 5, 6 and 9 are set to be equal to each other. However, it should be appreciated that the axial length h9 of the third stator core piece 9 may be set different from the axial lengths h5 and h6 of the first and second stator core pieces 5 and 6.

As a result, the stator core 1 according to the present embodiment is imparted a three-stepped skew structure, by which it is possible to smoothen the change in magnetic flux and thereby further reduce the magnetic noise generated by the motor.

Moreover, in the present embodiment, all of the sum of circumferential widths of the distal end part and the pair of the third protrusions 9a protruding from the distal end part for each of the tooth portions 3 in the third stator core piece 9, the sum of circumferential widths of the distal end part and the first protrusion 5a protruding from the distal end part for each of the tooth portions 3 in the first stator core piece 5, and the sum of circumferential widths of the distal end part and the second protrusions 6a protruding from the distal end part for each of the tooth portions 3 in the second stator core piece 6 are set to be equal to each other (i.e., equal to the predetermined value a). Consequently, it is possible to allow magnetic flux to be reliably transmitted from the rotor to the stator core 1 via the annular air gap formed therebetween, thereby effectively suppressing magnetic noise generated by the motor and decrease in the output torque of the motor.

### Fourth Embodiment

In the first embodiment, the stator core 1 is formed by stacking a pair of the first and second stator core sheets 5 and 6 in the axial direction. However, the stator core 1 may also be formed by stacking two or more pairs of the first and second stator core pieces in the axial direction.

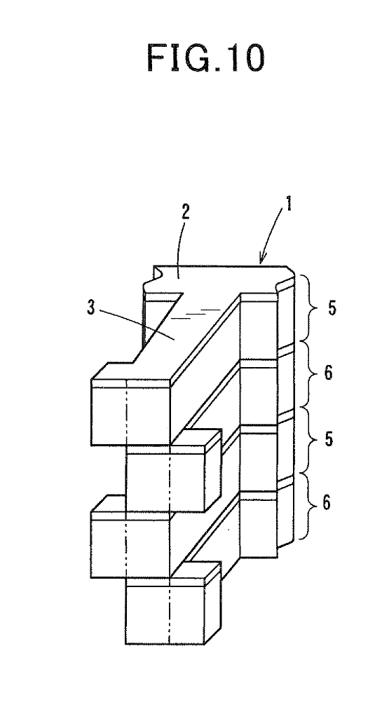

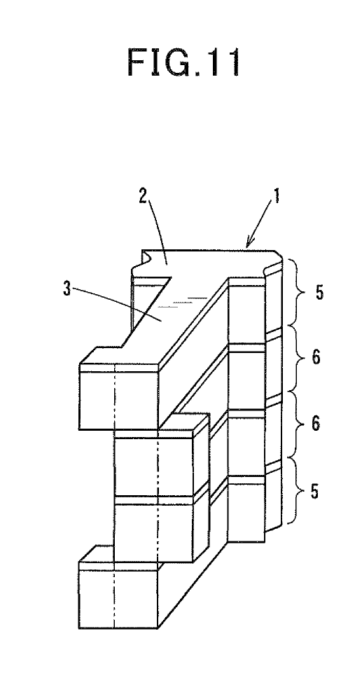

For example, as shown in FIGS. 10 and 11, the stator core 1 may be formed by stacking two pairs of the first and second stator core pieces 5 and 6 in the axial direction. Further, in the stator core 1, the first stator core pieces 5 may be alternately arranged with the second stator core pieces 6 in the axial direction, as shown in FIG. 10. Otherwise, it is also possible to first stack the second stator core pieces 6 together and then dispose the first stator core pieces 5 respectively on opposite axial sides of the stack of the second stator core pieces 6, as shown in FIG. 11.

### Fifth Embodiment

This embodiment illustrates a method of mounting a stator coil to the stator core 1 of the first embodiment.

Referring back to FIG. 2, in the stator core 1, for each of the slots 4 of the stator core 1, the first and second slot opening portions 7 and 8 that communicate with the slot 4 are offset from each other in the circumferential direction. In other words, the first and second slot opening portions 7 and 8 are out of alignment with each other in the axial direction of the stator core 1. Therefore, it is impossible to insert the stator coil from the radially inside of the stator core 1 into the slot 4 via the first and second slot opening portions 7 and 8.

On the other hand, each of the slots 4 is formed to continuously extend in the axial direction of the stator core 1 to penetrate the stator core 1. Therefore, it is possible to insert the stator coil into each of the slots 4 in the axial direction from either axial side of the stator core 1.

In view of the above, in the present embodiment, the stator coil is comprised of a plurality of conductor segments 10 that are severally inserted into corresponding ones of the slots 4 of the stator core 1 and then welded together.

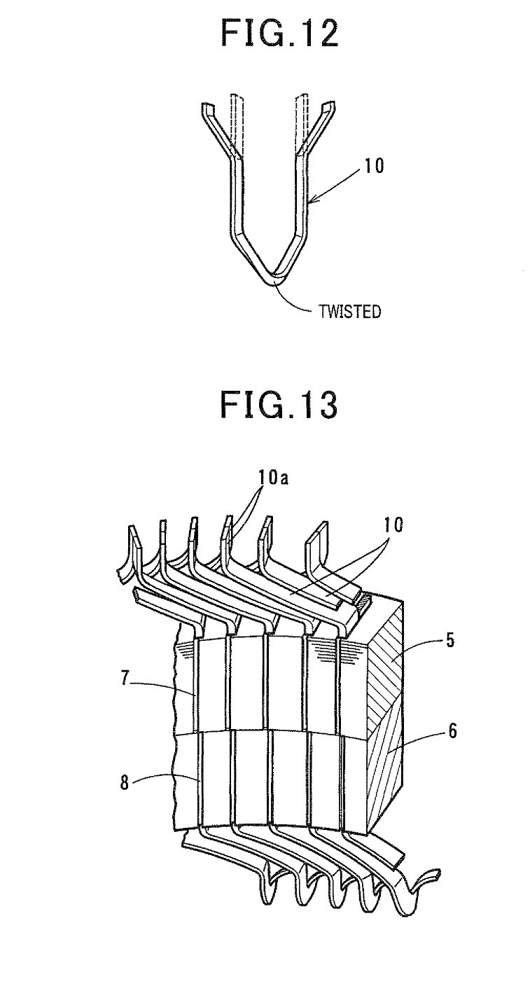

Specifically, referring to FIG. 12, each of the conductor segments 10 is first obtained by cutting a straight copper wire having, for example, a rectangular cross section into a predetermined length and then twisting it at the longitudinal center thereof into a substantially U-shape.

Next, referring to FIG. 13 together with FIG. 12, each of the conductor segments 10 is axially inserted into two corresponding slots 4 of the stator core 1 from one axial side (i.e., the lower side in FIG. 13) of the stator core 1. Then, for each of the conductor segments 10, end portions 10a of the conductor segment 10 which protrude respectively from the two corresponding slots 4 on the other axial side (i.e., the upper side in FIG. 13) of the stator core 1 are bent toward mutually opposite directions. Thereafter, corresponding pairs of the end portions 10a of the conductor segments 10 are joined together by, for example, welding, forming the stator coil of the stator.

With the above method according to the present embodiment, it is possible to reliably mount the stator coil to (or form the stator coil on) the stator core 1 even with the stepped skew structure of the stator coil 1.

Moreover, with the above method according to the present embodiment, it is possible to mount the stator coil at a higher density in comparison with a conventional method of forming a stator coil by winding a continuous copper wire around a stator core.

### Sixth Embodiment

In the first embodiment, each of the first and second stator core pieces 5 and 6 is formed as one integral piece. However, each of the first and second stator core pieces 5 and 6 may also be obtained by first forming the back yoke portion 2 and the tooth portions 3 separately and then joining them together by means well known in the art.

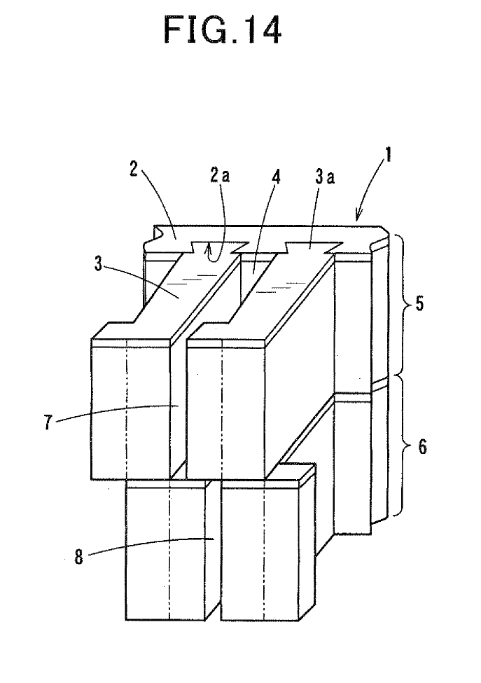

For example, as shown in FIG. 14, for each of the first and second core pieces 5 and 6, the back yoke portion 2 and the tooth portions 3 may be separately formed so that the back yoke portion 2 has a plurality of recesses 2a formed in the radially inner surface thereof and each of the tooth portions 3 has a protrusion 3a formed on the radially outer surface thereof. Then, the back yoke portion 2 and the tooth portions 3 may be joined together by fitting each of the protrusions 3a of the tooth portions 3 into a corresponding one of the recesses 2a of the back yoke portion 2. Accordingly, in this case, the protrusions 3a and the recesses 2a together make up the means for joining the back yoke portion 2 and the tooth portions 3 together. In addition, though not graphically shown, it is also possible to connect all of the distal end parts of the tooth portions 3 using an annular connecting bar.

With the above separate formation of the back yoke portion 2 and the tooth portions 3, it is possible to mount a stator coil to the stator core 1 by first inserting the stator coil into the slots 4 formed between the tooth portions 3 from the radially outside and then joining the back yoke portion 2 to the tooth portions 3.

### Seventh Embodiment

In the first embodiment, the stator core 1 is designed to be used in an inner rotor-type motor in which the rotor is disposed radially inside the stator.

In comparison, in this embodiment, the stator core 1 is designed to be used in an outer rotor-type motor in which the rotor is disposed radially outside the stator.

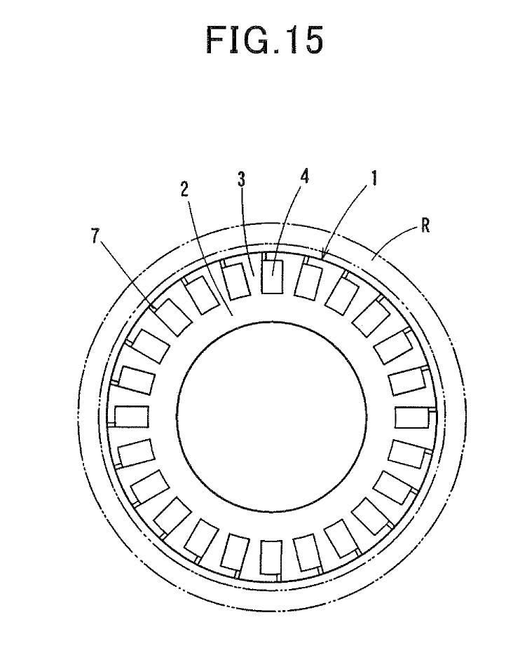

Specifically, as shown in FIG. 15, in the present embodiment, the stator core 1 has the rotor R disposed radially outside thereof. The stator core 1 includes an annular back yoke portion 2, a plurality of tooth portions 3 and a plurality of slots 4. Each of the tooth portions 3 extends radially outward from a radially outer periphery of the back yoke portion 2. The tooth portions 3 are arranged at predetermined intervals in the circumferential direction of the stator core 1 (i.e., in the circumferential direction of the annular back yoke portion 2). Each of the slots 4 is formed between a circumferentially-adjacent pair of the tooth portions 3.

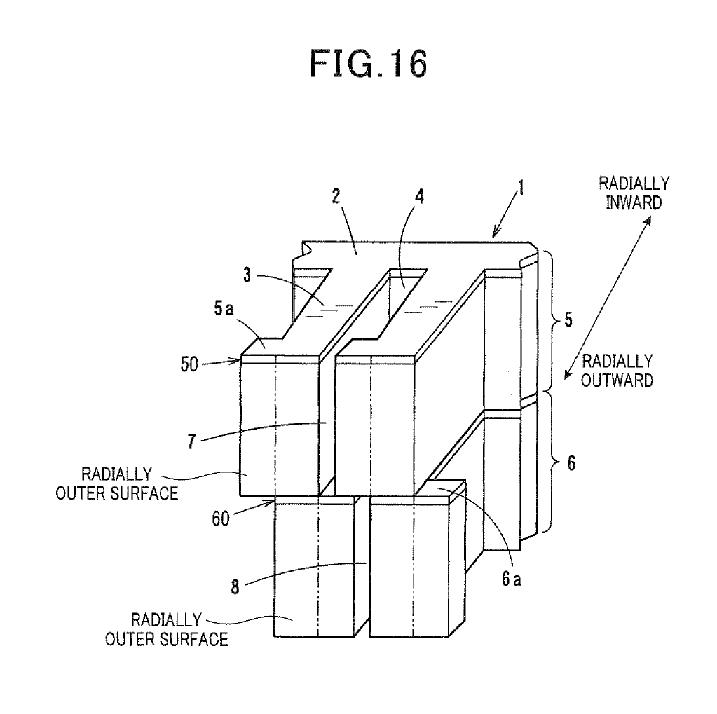

Further, referring to FIG. 16, in the present embodiment, the stator core 1 is also comprised of first and second stator core pieces 5 and 6 that are arranged to overlap each other in the axial direction of the stator core 1. The first stator core piece 5 includes a plurality of first protrusions 5a each of which is formed on a first circumferential side (i.e., the left side in FIG. 16) of a corresponding one of the tooth portions 3 of the stator core I so as to protrude from a distal end part of the corresponding tooth portion 3 in the circumferential direction. The second stator core piece 6 includes a plurality of second protrusions 6a each of which is formed on a second circumferential side (i.e., the right side in FIG. 16) of a corresponding one of the tooth portions 3 of the stator core 1 so as to protrude from the distal end part of the corresponding tooth portion 3 in the circumferential direction. In addition, for each of the tooth portions 3 of the stator core 1, the first and second circumferential sides of the tooth portion 3 are opposite to each other.

Moreover, the first stator core piece 5 also includes a plurality of first slot opening portions 7 each of which is formed between a circumferentially-adjacent pair of one of the first protrusions 5a and one of the distal end parts of the tooth portions 3. Each of the first slot opening portions 7 communicates with a corresponding one of the slots 4 of the stator core 1 and opens on the radially outer surface of the first stator core piece 5. On the other hand, the second stator core piece 6 also includes a plurality of second slot opening portions 8 each of which is formed between a circumferentially-adjacent pair of one of the second protrusions 6a and one of the distal end parts of the tooth portions 3. Each of the second slot opening portions 8 communicates with a corresponding one of the slots 4 of the stator core 1 and opens on the radially outer surface of the second stator core piece 6. In addition, the radially outer surfaces of the first and second stator core pieces 5 and 6 face the rotor R of the motor. Consequently, each of the slots 4 of the stator core 1 can communicate with an annular gap formed between the stator and the rotor of the motor via the corresponding pair of the first and second slot opening portions 7 and 8.

In the stator core 1 that is obtained by stacking the first and second stator core pieces 5 and 6 in the axial direction, for each of the slots 4, the corresponding pair of the first and second slot opening portions 7 and 8, both of which communicate with the slot 4 and extend in the axial direction of the stator core 1, are offset from each other in the circumferential direction of the stator core 1. That is to say, all of the first slot opening portions 7 opening on the radially outer surface of the first stator core piece 5 and the second slot opening portions 8 opening on the radially outer surface of the second stator core piece 6 together make up a stepped skew structure of the stator core 1.

Furthermore, in the present embodiment, the first stator core piece 5 is formed by laminating a plurality of first stator core sheets 50. The second stator core piece 6 is formed by laminating a plurality of second stator core sheets 60. Further, as in the first embodiment, the thickness of the first stator core sheets 50 is equal to that of the second stator core sheets 60, and the shape of the first stator core sheets 50 and the shape of the second stator core sheets 60 are mirror images of each other. The axial length of the first stator core piece 5 is equal to that of the second stator core piece 6. The circumferential width of the first and second protrusions 5a and 6a is set to be greater than the circumferential width of the first and second slot opening portions 7 and 8 on the radially outer surfaces of the first and second stator core pieces 5 and 6.

The stator core 1 according to the present embodiment has the same advantages as that according to the first embodiment.

While the above particular embodiments of the present invention have been shown and described, it will be understood by those skilled in the art that various modifications, changes, and improvements may be made without departing from the spirit of the invention.

For example, in the previous embodiments, the present invention is directed to the stators for permanent magnet synchronous motors. However, it is also possible to apply the present invention to stators for other electric rotating machines, such as induction motors, reluctance motors and synchronous electric generators.

Moreover, in the first to the sixth embodiments, the stator core 1 is designed to be used in an inner rotor-type motor. On the other hand, in the seventh embodiment, the stator core 1 is designed to be used in an outer rotor-type motor. However, it is also possible to combine the stator core structure according to the seventh embodiment with those according to the first to the sixth embodiments.

For example, it is possible to configure a stator core for a double rotor-type motor to have a structure that is a combination of the stator core structures according to the first and seventh embodiments. More specifically, the double rotor-type motor includes both an inner rotor disposed radially inside the stator core and an outer rotor disposed radially outside the stator core. The stator core includes an annular back yoke portion, a plurality of radially-inner tooth portions, a plurality of radially-inner slots, a plurality of radially-outer tooth portions and a plurality of radially-outer slot portions. Each of the radially-inner tooth portions extends radially inward from a radially inner periphery of the back yoke portion. The radially-inner tooth portions are arranged at predetermined intervals in the circumferential direction of the stator core. Each of the radially-inner slots is formed between a circumferentially-adjacent pair of the radially-inner tooth portions. Each of the radially-outer tooth portions extends radially outward from a radially outer periphery of the back yoke portion. The radially-outer tooth portions are arranged at predetermined intervals in the circumferential direction of the stator core. Each of the radially-outer slots is formed between a circumferentially-adjacent pair of the radially-outer tooth portions. Further, the stator core is also comprised of first and second stator core pieces that are arranged to overlap each other in the axial direction of the stator core. The first stator core piece includes a plurality of first radially-inner protrusions and a plurality of first radially-outer protrusions. Each of the first radially-inner protrusions is formed on a first circumferential side of a corresponding one of the radially-inner tooth portions of the stator core so as to protrude from a distal end part of the corresponding radially-inner tooth portion in the circumferential direction. Each of the first radially-outer protrusions is formed on a first circumferential side of a corresponding one of the radially-outer tooth portions of the stator core so as to protrude from a distal end part of the corresponding radially-outer tooth portion in the circumferential direction. The second stator core piece includes a plurality of second radially-inner protrusions and a plurality of second radially-outer protrusions. Each of the second radially-inner protrusions is formed on a second circumferential side of a corresponding one of the radially-inner tooth portions of the stator core so as to protrude from a distal end part of the corresponding radially-inner tooth portion in the circumferential direction. Each of the second radially-outer protrusions is formed on a second circumferential side of a corresponding one of the radially-outer tooth portions of the stator core so as to protrude from a distal end part of the corresponding radially-outer tooth portion in the circumferential direction. In addition, the first and second circumferential sides are opposite to each other for each of the radially-inner and radially-outer tooth portions of the stator core. Moreover, the first stator core piece also includes a plurality of first radially-inner slot opening portions and a plurality of first radially-outer slot opening portions. Each of the first radially-inner slot opening portions is formed between a circumferentially-adjacent pair of one of the first radially-inner protrusions and one of the distal end parts of the radially-inner tooth portions. Each of the first radially-inner slot opening portions communicates with a corresponding one of the radially-inner slots of the stator core and opens on the radially inner surface of the first stator core piece. Each of the first radially-outer slot opening portions is formed between a circumferentially-adjacent pair of one of the first radially-outer protrusions and one of the distal end parts of the radially-outer tooth portions. Each of the first radially-outer slot opening portions communicates with a corresponding one of the radially-outer slots of the stator core and opens on the radially outer surface of the first stator core piece. On the other hand, the second stator core piece also includes a plurality of second radially-inner slot opening portions and a plurality of second radially-outer slot opening portions. Each of the second radially-inner slot opening portions is formed between a circumferentially-adjacent pair of one of the second radially-inner protrusions and one of the distal end parts of the radially-inner tooth portions. Each of the second radially-inner slot opening portions communicates with a corresponding one of the radially-inner slots of the stator core and opens on the radially inner surface of the second stator core piece. Each of the second radially-outer slot opening portions is formed between a circumferentially-adjacent pair of one of the second radially-outer protrusions and one of the distal end parts of the radially-outer tooth portions. Each of the second radially-outer slot opening portions communicates with a corresponding one of the radially-outer slots of the stator core and opens on the radially outer surface of the second stator core piece. Furthermore, in the stator core that is obtained by stacking the first and second stator core pieces in the axial direction, for each of the radially-inner slots, the corresponding pair of the first and second radially-inner slot opening portions, both of which communicate with the radially-inner slot and extend in the axial direction of the stator core, are offset from each other in the circumferential direction of the stator core. For each of the radially-outer slots, the corresponding pair of the first and second radially-outer slot opening portions, both of which communicate with the radially-outer slot and extend in the axial direction of the stator core, are offset from each other in the circumferential direction of the stator core.

What is claimed is:

1. A stator for an electric rotating machine, the stator comprising a stator core that includes an annular back yoke portion, a plurality of tooth portions and a plurality of slots, each of the tooth portions extending radially inward from a radially inner periphery of the back yoke portion, the tooth portions being arranged in a circumferential direction of the back yoke portion at predetermined intervals, each of the slots being formed between a circumferentially-adjacent pair of the tooth portions,
wherein
the stator core is comprised of first and second stator core pieces that are arranged to overlap each other in an axial direction of the back yoke portion of the stator core,
the first stator core piece includes a plurality of first protrusions and a plurality of first slot opening portions, each of the first protrusions being formed on a first circumferential side of a corresponding one of the tooth portions of the stator core so as to protrude from a distal end part of the corresponding tooth portion in the circumferential direction, each of the first slot opening portions being formed between a circumferentially-adjacent pair of one of the first protrusions and one of the distal end parts of the tooth portions of the stator core so as to extend in the axial direction, each of the first slot opening portions communicating with a corresponding one of the slots of the stator core and opening on a radially inner surface of the first stator core piece,
the second stator core piece includes a plurality of second protrusions and a plurality of second slot opening portions, each of the second protrusions being formed on a second circumferential side of a corresponding one of the tooth portions of the stator core so as to protrude from the distal end part of the corresponding tooth portion in the circumferential direction, the second circumferential side being opposite to the first circumferential side for each of the tooth portions of the stator core, each of the second slot opening portions being formed between a circumferentially-adjacent pair of one of the second protrusions and one of the distal end parts of the tooth portions of the stator core so as to extend in the axial direction, each of the second slot opening portions communicating with a corresponding one of the slots of the stator core and opening on a radially inner surface of the second stator core piece, and
for each of the slots of the stator core, the corresponding pair of the first and second slot opening portions which communicate with the slot are offset from each other in the circumferential direction of the back yoke portion of the stator core.

2. The stator as set forth in claim 1, wherein the first stator core piece is formed of a plurality of first stator core sheets that are laminated in the axial direction of the back yoke portion of the stator core, and the second stator core piece is formed of a plurality of second stator core sheets that are laminated in the axial direction.

3. The stator as set forth in claim 2, wherein the thickness of the first stator core sheets is equal to the thickness of the second stator core sheets, and the shape of the first stator core sheets and the shape of the second stator core sheets are mirror images of each other.

4. The stator as set forth in claim 1, wherein the axial length of the first stator core piece is equal to the axial length of the second stator core piece.

5. The stator as set forth in claim 1, wherein the circumferential width of the first and second protrusions is set to be greater than the circumferential width of the first and second slot opening portions on the radially inner surfaces of the first and second stator core pieces.

6. The stator as set forth in claim 1, wherein the first stator core piece further includes a plurality of second protrusions each of which is formed on the second circumferential side of a corresponding one of the tooth portions of the stator core so as to protrude from the distal end part of the corresponding tooth portion in the circumferential direction, the second protrusions having a smaller circumferential width than the first protrusions of the first stator core piece, and
the second stator core piece further includes a plurality of first protrusions each of which is formed on the first circumferential side of a corresponding one of the tooth portions of the stator core so as to protrude from the distal end part of the corresponding tooth portion in the circumferential direction, the first protrusions having a smaller circumferential width than the second protrusions of the second stator core piece.

7. The stator as set forth in claim 1, wherein the stator core further includes a third stator core piece that is interposed between the first and second stator core pieces in the axial direction,
in the third stator core piece, for each of the tooth portions of the stator core, there are formed a pair of third protrusions respectively on the first and second circumferential sides of the tooth portion so as to protrude from the distal end part of the tooth portion in the circumferential direction,
the circumferential width of the third protrusions formed on the first circumferential side of the tooth portions is set to be less than the circumferential width of the first protrusions of the first stator core piece, and
the circumferential width of the third protrusions formed on the second circumferential side of the tooth portions is set to be less than the circumferential width of the second protrusions of the second stator core piece.

8. The stator as set forth in claim 7, wherein in the first stator core piece, for each of the tooth portions of the stator core, the sum of circumferential widths of the distal end part of the tooth portion and the first protrusion protruding from the distal end part is set to be equal to a predetermined value,
in the second stator core piece, for each of the tooth portions of the stator core, the sum of circumferential widths of the distal end part of the tooth portion and the second protrusion protruding from the distal end part is also set to be equal to the predetermined value, and
in the third stator core piece, for each of the tooth portions of the stator core, the sum of circumferential widths of the distal end part of the tooth portion and the pair of the third protrusions protruding from the distal end part is also set to be equal to the predetermined value.

9. The stator as set forth in claim 1, further comprising a stator coil mounted on the stator core, wherein the stator coil is comprised of a plurality of substantially U-shaped conductor segments that are axially inserted in corresponding ones of the slots of the stator core from one axial side of the stator core, and corresponding pairs of end portions of the conductor segments, which protrude from the corresponding slots of the stator core on the other axial side of the stator core, are joined together.

10. The stator as set forth in claim 1, wherein in each of the first and second core pieces, the back yoke portion and the tooth portions are separately formed and joined together by a joining means.

11. The stator as set forth in claim 1, wherein the tooth portions are radially-inner tooth portions, the slots are radially-inner slots, the first protrusions are first radially-inner protrusions, the first slot opening portions are first radially-inner slot opening portions, the second protrusions are second radially-inner slot opening portions and the second slot opening portions are second radially-inner slot opening portions,
the stator core further includes a plurality of radially-outer tooth portions and a plurality of radially-outer slots, each of the radially-outer tooth portions extending radially outward from a radially outer periphery of the back yoke portion, the radially-outer tooth portions being arranged in the circumferential direction of the back yoke portion at predetermined intervals, each of the radially-outer slots being formed between a circumferentially-adjacent pair of the radially-outer tooth portions,
the first stator core piece further includes a plurality of first radially-outer protrusions and a plurality of first radially-outer slot opening portions, each of the first radially-outer protrusions being formed on a first circumferential side of a corresponding one of the radially-outer tooth portions of the stator core so as to protrude from a distal end part of the corresponding radially-outer tooth portion in the circumferential direction, each of the first radially-outer slot opening portions being formed between a circumferentially-adjacent pair of one of the first radially-outer protrusions and one of the distal end parts of the radially-outer tooth portions of the stator core so as to extend in the axial direction, each of the first radially-outer slot opening portions communicating with a corresponding one of the radially-outer slots of the stator core and opening on a radially outer surface of the first stator core piece,
the second stator core piece further includes a plurality of second radially-outer protrusions and a plurality of second radially-outer slot opening portions, each of the second radially-outer protrusions being formed on a second circumferential side of a corresponding one of the radially-outer tooth portions of the stator core so as to protrude from the distal end part of the corresponding radially-outer tooth portion in the circumferential direction, the second circumferential side being opposite to the first circumferential side for each of the radially-outer tooth portions of the stator core, each of the second radially-outer slot opening portions being formed between a circumferentially-adjacent pair of one of the second radially-outer protrusions and one of the distal end parts of the radially-outer tooth portions of the stator core so as to extend in the axial direction, each of the second radially-outer slot opening portions communicating with a corresponding one of the radially-outer slots of the stator core and opening on a radially outer surface of the second stator core piece, and
for each of the radially-outer slots of the stator core, the corresponding pair of the first and second radially-outer slot opening portions which communicate with the radially-outer slot are offset from each other in the circumferential direction of the back yoke portion of the stator core.

12. A stator for an electric rotating machine, the stator comprising a stator core that includes an annular back yoke portion, a plurality of tooth portions and a plurality of slots, each of the tooth portions extending radially outward from a radially outer periphery of the back yoke portion, the tooth portions being arranged in a circumferential direction of the back yoke portion at predetermined intervals, each of the slots being formed between a circumferentially-adjacent pair of the tooth portions,
wherein
the stator core is comprised of first and second stator core pieces that are arranged to overlap each other in an axial direction of the back yoke portion of the stator core,
the first stator core piece includes a plurality of first protrusions and a plurality of first slot opening portions, each of the first protrusions being formed on a first circumferential side of a corresponding one of the tooth portions of the stator core so as to protrude from a distal end part of the corresponding tooth portion in the circumferential direction, each of the first slot opening portions being formed between a circumferentially-adjacent pair of one of the first protrusions and one of the distal end parts of the tooth portions of the stator core so as to extend in the axial direction, each of the first slot opening portions communicating with a corresponding one of the slots of the stator core and opening on a radially outer surface of the first stator core piece,
the second stator core piece includes a plurality of second protrusions and a plurality of second slot opening portions, each of the second protrusions being formed on a second circumferential side of a corresponding one of the tooth portions of the stator core so as to protrude from the distal end part of the corresponding tooth portion in the circumferential direction, the second circumferential side being opposite to the first circumferential side for each of the tooth portions of the stator core, each of the second slot opening portions being formed between a circumferentially-adjacent pair of one of the second protrusions and one of the distal end parts of the tooth portions of the stator core so as to extend in the axial direction, each of the second slot opening portions communicating with a corresponding one of the slots of the stator core and opening on a radially outer surface of the second stator core piece, and
for each of the slots of the stator core, the corresponding pair of the first and second slot opening portions which communicate with the slot are offset from each other in the circumferential direction of the back yoke portion of the stator core.

13. The stator as set forth in claim 12, wherein the first stator core piece is formed of a plurality of first stator core sheets that are laminated in the axial direction of the back yoke portion of the stator core, and the second stator core piece is formed of a plurality of second stator core sheets that are laminated in the axial direction.

14. The stator as set forth in claim 13, wherein the thickness of the first stator core sheets is equal to the thickness of the second stator core sheets, and the shape of the first stator core sheets and the shape of the second stator core sheets are mirror images of each other.

15. The stator as set forth in claim 12, wherein the axial length of the first stator core piece is equal to the axial length of the second stator core piece.

16. The stator as set forth in claim 12, wherein the circumferential width of the first and second protrusions is set to be greater than the circumferential width of the first and second slot opening portions on the radially outer surfaces of the first and second stator core pieces.
